(19) United States
(12) Patent Application Publication
(10) Pub. No.: US 2021/0053756 A1
(43) Pub. Date: Feb. 25, 2021

(54) Reusable Bin Liner

(71) Applicant: Stephanie Joyce Tinker, Chilliwack (CA)

(72) Inventor: Stephanie Joyce Tinker, Chilliwack (CA)

(21) Appl. No.: 16/546,522

(22) Filed: Aug. 21, 2019

(51) Int. Cl. B65F 1/06

(52) U.S. Cl. CPC B65F 1/06; B65F 2250/114

(57) ABSTRACT

A reusable bin liner secured inside a bin body to prevent the liner to slip when the bin is emptied while being removable for cleaning.

### BACKGROUND OF THE INVENTION

### 1. Field of the Invention

The present invention is generally directed toward a bin liner, and more specifically to a removable bin liner.

### 2. Description of the Related Art

Bins such as garbage cans, recycling containers, composting bins quickly get dirty and smelly and are very difficult to clean. For composting bins, some municipalities allow to use compostable bags to contain the compostable waste, but these compostable/biodegradable bags are expensive, messy and can hinder the composting process for service providers.

There is a need for a reusable liner that is secured/fitted to the bin so it will not fall when the bin is emptied, while is capable of being removable for cleaning.

### SUMMARY OF THE INVENTION

In one aspect, a bin liner for use with a bin having a bin body having a generally hollow cylindrical or rectangular prism shape and being closed at the bottom and having an upper ledge is disclosed. The bin liner includes a flexible liner having a shape being slightly smaller than the bin body and having a closed bottom and an open upper end. The liner being constructed from a flexible material such that the liner does not fall when the bin is emptied.

In some aspects, the liner is constructed from a substantially flexible material such as a silicon material.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The figures which accompany the written portion of this specification illustrate embodiments and method(s) of use for the present invention constructed and operative according to the teachings of the present invention.

To easily identify the discussion of any particular element or act, the most significant digit or digits in a reference number refer to the figure number in which that element is first introduced.

FIG. 1 illustrates a prior art trash bin.

FIG. 2 depicts an embodiment of a bin liner according to aspects of the present invention inserted inside the body of the bin.

FIG. 3 illustrates an embodiment of a bin liner according to aspects of the present invention being folded on the ledge.

The various embodiments of the present invention will hereinafter be described in conjunction with the appended drawings, wherein like designations denote like elements.

### DETAILED DESCRIPTION

The present invention is generally directed toward a bin liner, and more specifically to a removable bin liner.

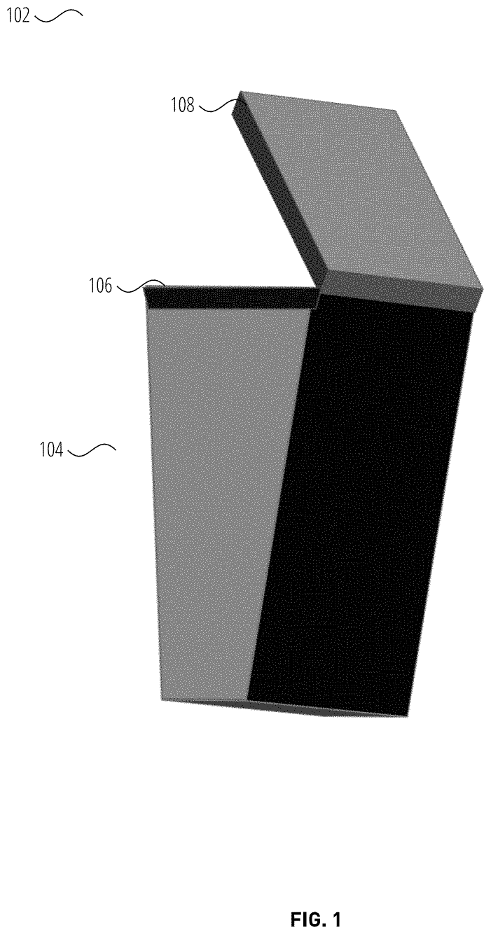

FIG. 1 illustrates a typical bin 102 such as garbage cans, recycling containers, composting bins. The bin is made of a body 104, generally of hollow cylindrical or rectangular prism shape closed at the bottom with an upper ledge 106. The bin 102 optionally has a lid 108.

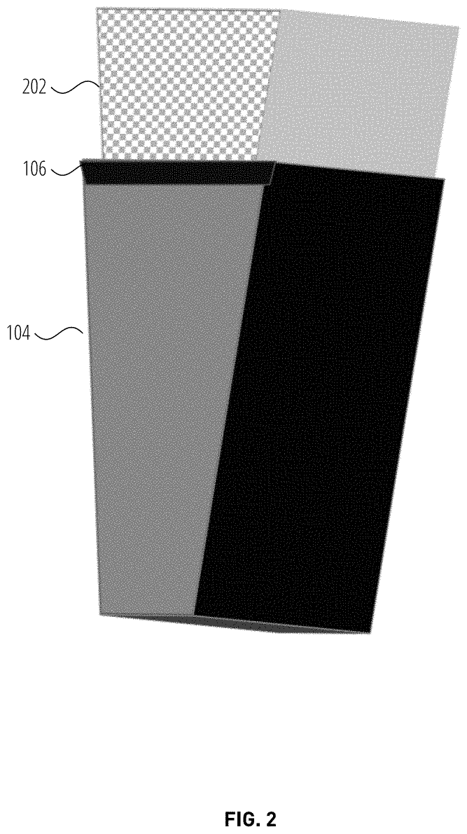

FIG. 2 depicts a liner 202 inserted inside the body 104 of the bin. The liner is made of substantially flexible material preferably silicon, or any other type of material that can be shaped to fit closely to the inside of the body 104. Preferably the material is non-stick, does not hold odor and can be cleaned with water and any type of cleaning products. Preferably, the liner 202 can be turned inside out for cleaning and returned to its original side without losing its shape.

The liner 202 is designed with a shape similar but slightly smaller than the inside of the bin body 104.

The liner 202 is secured to the body 104 such that the liner 202 will not slide out when the bin 102 is emptied. The liner 202 can be removed for cleaning and reinserted for more usage.

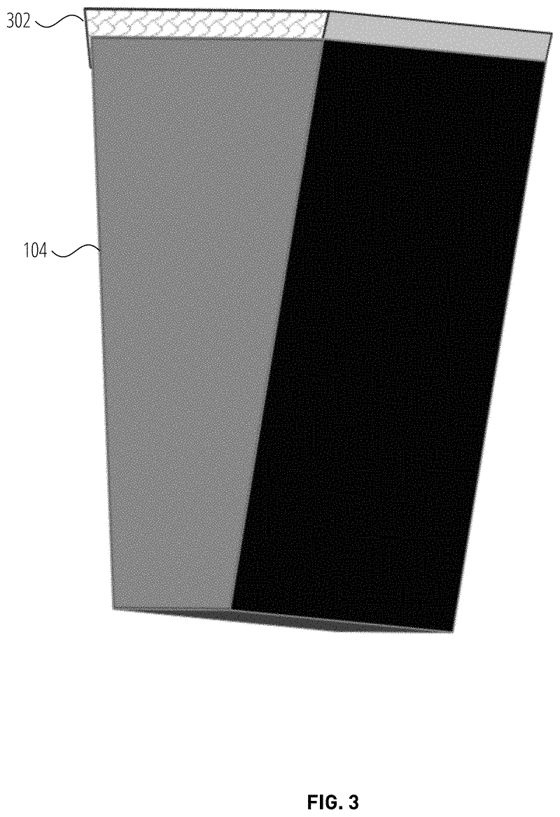

FIG. 3 illustrates the liner being folded on the ledge of the bin to secure the liner 202 on the bin 102 and prevent it from falling when the bin 102 is emptied.

In another embodiment, the top of the liner 202 is secured to the bin using clamping devices such as a clips.

In another embodiment, the size of the liner 202 is such that the liner snuggly fits into the bin and will not slide out unless some force is applied to take the liner 202 out. In some embodiments, the liner 202 may be folded or bent in half to allow the liner 202 to be pulled out of the bin 102.

In another embodiment, the liner is sized such that it fits snugly in the inside portion and requires a tug to be removed from the bin 102.

The exact specifications and materials used in the manufacture of the apparatus of the present invention may vary upon manufacturing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

I claim:

1. A bin liner for use with a bin having a bin body having a generally hollow cylindrical or rectangular prism shape and being closed at the bottom and having an upper ledge 106, the bin liner comprising:
a flexible liner having a shape being slightly smaller than the bin body and having a closed bottom and an open upper end, the liner being constructed from a flexible material such that the liner does not fall when the bin is emptied.

2. The reusable liner of claim 1 wherein the liner is secured by folding the liner on a ledge of said bin.

3. The reusable liner of claim 1 wherein the liner is secured using one or more clip on a ledge of said bin.

4. The reusable liner of claim 1 wherein the liner is sized such that it fits snugly in the inside portion and requires a tug to be removed.

5. The reusable liner of claim 1 wherein said liner is substantially flexible.

6. The reusable liner of claim 1 wherein said liner is comprised of silicon material.
